(19) United States
(12) Patent Application Publication
(10) Pub. No.: US 2024/0185129 A1
(43) Pub. Date: Jun. 6, 2024

(54) METHODS AND APPARATUS TO FACILITATE COLLABORATIVE LEARNING IN A MULTI-SENSOR ENVIRONMENT

(71) Applicant: Intel Corporation, Santa Clara, CA (US)

(72) Inventors: Priyanka Mudgal, Portland, OR (US); Caleb Mark McMillan, Forest Grove, OR (US); Rita Hanna Wouhaybi, Portland, OR (US); Mark David Yarvis, Portland, OR (US); Jennifer Williams, Hillsboro, OR (US); Greeshma Pisharody, Portland, OR (US)

(21) Appl. No.: 18/415,588

(22) Filed: Jan. 17, 2024

(51) Int. Cl. G06N 20/00

(52) U.S. Cl. CPC G06N 20/00

(57) ABSTRACT

Methods, apparatus, systems, and articles of manufacture to facilitate collaborative learning in a multi-sensor environment are disclosed. An example computer readable medium comprises instructions at least one programmable circuit to after determining that first data from a first device conflicts with second data from a second device: validate the first device based on third data from a validated device; and mitigate the second device based on the third data.

### FIELD OF THE DISCLOSURE

This disclosure relates generally to distributed networks and, more particularly, to methods and apparatus to facilitate collaborative learning in a multi-sensor environment.

### BACKGROUND

A distributed network (sometimes referred to as a cluster network) is a network of computing devices (e.g., nodes and servers) that work together to execute one or more tasks. The computing devices in such a network may perform different portions of the one or more tasks (e.g., to increase speed and/or performance) and/or may perform the same portion(s) of the one or more tasks (e.g., for high availability to mitigate problems after one or more nodes fail). A group of nodes, which may be managed by a central plane node, is referred to as a cluster or fleet.

### BRIEF DESCRIPTION OF THE DRAWINGS

FIG. 1 is a block diagram of an example multi-sensor environment.

FIG. 2 is a block diagram of an example implementation of the system control circuitry of FIG. 1.

FIGS. 3A-3B are a flowchart representative of example machine readable instructions and/or operations that may be executed, instantiated, and/or performed by programmable circuitry to implement the example system control circuitry of FIG. 2.

FIG. 4 is a block diagram of an example processor platform including programmable circuitry structured to execute, instantiate, and/or perform the computer readable instructions and/or perform the example operations of FIGS. 3A-3B to implement the system control circuitry of FIG. 2.

FIG. 5 is a block diagram of an example implementation of the programmable circuitry of FIG. 4.

FIG. 6 is a block diagram of another example implementation of the programmable circuitry of FIG. 4.

FIG. 7 is a block diagram of an example software/firmware/instructions distribution platform (e.g., one or more servers) to distribute software, instructions, and/or firmware (e.g., corresponding to the example machine readable instructions of FIG. 4) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

In some applications of distributed networks, computing devices analyze information from edge devices (e.g., sensors) and relay the information to other edge, fog, central, cloud, and/or node circuitry to perform tasks (e.g., related to automation optimization, data processing, visualization of the analyzed data, etc.). The data analysis circuits (e.g., cloud circuitry) can respond to issues related to one or more objects detected and/or tracked by the edge-based devices in real-time or substantially real-time. Such nodes, devices and/or systems may include a group or fleet of nodes and/or compute nodes that can co-operatively process a workload to efficiently execute functions, process data, etc.

In some distributed systems, devices that include and/or are connected to sensors process data locally and send processed data to a central entity. For example, a warehouse may include processing nodes or devices throughout the warehouse that include or are in communication with sensors that track items in the warehouse. The processing nodes and/or devices may include models (e.g., AI-based models) to classify the obtained sensor data from the sensor and transmit the classification information to a central entity.

Misclassification of information by a processing node may be due to any of a plurality of reasons. For example, any one or more of low quality sensors, poor lighting, bad image angles, poorly trained classification models, model drift, poorly located sensors, capability of the processing node, etc. can lead to misclassifications. Accordingly, in a system that includes multiple sensors that can classify the same tracked object, some nodes may classify the tracked object correctly, while other nodes may misclassify the tracked object. For example, in a warehouse setting, some cameras may be installed on the entryway facing different angles and other cameras may be located at a different location inside the warehouse. In such an environment, the lighting conditions may be different in the entryway as compared to locations near the entryway. Accordingly, detection results from a model implemented on nodes connected to the different cameras could vary. For example, even though a defect in a tracked object may be visible to two cameras, a first node may classify the tracked object sensed by the first camera as defective with a 70% confidence score, while a second node processing data from the second camera deployed at a different location may classify the tracked object as non-defective with a low confidence score. In such an example, without more details, it becomes difficult to decide which node is correct and manual intervention may be required. Until a decision is made, the inaccurate node continues to consume power and/or other resources while making inaccurate classifications.

Examples disclosed herein find conflicts (e.g., different classifications) from processed data in a group or cluster of data across a plurality of nodes. The groups and/or clusters of data correspond to data that have one or more aspects in common (e.g., the data corresponds to the same tracked item within a threshold amount of time). After identifying a conflict, examples disclosed herein determine the correct classification using a verified node. A verified node may be a node that has been identified as being accurate (e.g., based on historical data) and/or having more and/or better resources than other nodes (e.g., better sensor, implementing a robust classification model, etc.). If the cluster of data includes data from a verified node, in some examples, the classification of the verified node is determined to be accurate. If there is no verified node corresponding the cluster of data, the image capture data may be processed by a verified node that does not correspond to the cluster of data to determine if the verified node agrees or disagrees with the conflicting classifications. In some examples, the verified node is a node that is implemented in mobile validation unit (e.g., a drone, a robot, or other mobile device). In such examples, the mobile validation unit can move to the location where the data that corresponds to a conflict was originally captured and capture image data with a sensor and process the results to determine which classification is accurate.

After examples disclosed herein identify a node that has misclassified data, examples disclosed herein perform one or more mitigation actions to attempt to avoid future misclassifications and/or to conserve resources. Mitigation actions may include adjusting the settings of the node and/or sensor (e.g., to brighten a flash), adjusting settings of the environment (e.g., to turn on a light), retraining the algorithm implemented by a node, powering down a node, increasing the trust (e.g., confidence) score of a node (e.g., after a node correctly classifies data), decreasing the trust score of a node (e.g., after a node incorrectly classifies data), promoting a node to a validator node, demoting a node from a validator node, reprocessing the sensed data, sending the sensed data to another node to process, recapture additional sensor data, re-routing a tracked item to another area, etc. Accordingly, examples disclosed herein automatically increase the accuracy of classification systems while also conserving resources by powering down devices that are not accurate, thereby improving system efficiency.

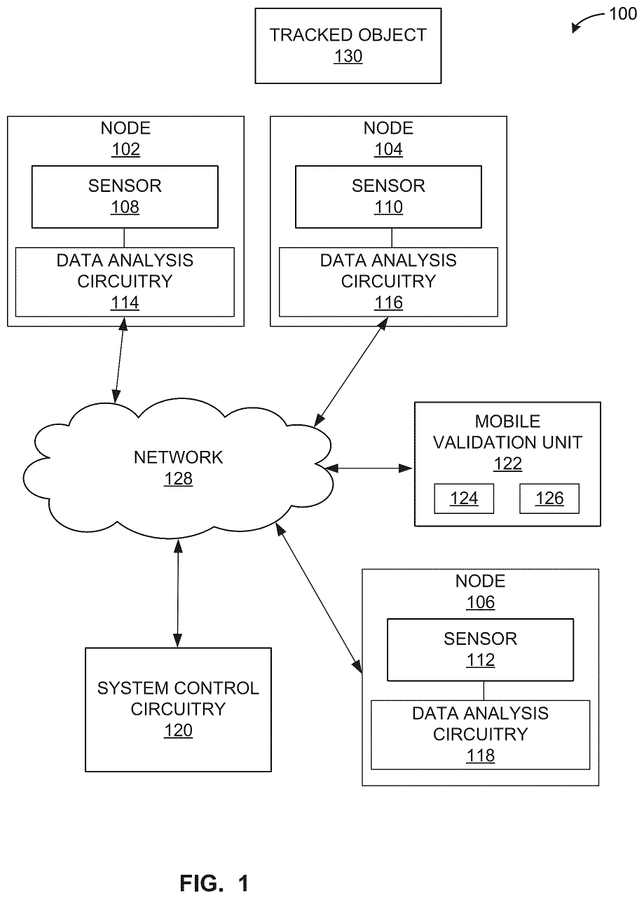

FIG. 1 is a system diagram in which collaborative learning occurs in an example multi-sensor environment 100. The example distributed multi-sensor environment 100 includes example nodes 102, 104, 106, example sensors 108, 110, 112, 124, example data analysis circuitry 114, 116, 118, 126, example system control circuitry 120, an example mobile validation unit 122, an example network 128, and an example tracked object 130. There may be any number of nodes, sensors, and/or mobile validation units in the multi-sensor environment 100.

The example nodes 102, 104, 106 of FIG. 1 may be personal computers, tablets, servers, phones, cameras, mobile devices, and/or any other type(s) of computing devices. The example nodes 102, 104, 106 may be located in different locations throughout the environment 100. In some examples, the nodes 102, 104, 106 and/or a portion of the nodes 102, 104, 106 may be mobile. For example, if a node (e.g., node 102, 104, or 106) corresponds to a camera, the camera and/or the entire node may be able to rotate and/or move to obtain image(s) from different angles. The nodes 102, 104, 106 include the corresponding sensors 108, 110, 112. However, in some examples, the nodes 102, 104, 106 may be connected to (e.g., via a wired or wireless connection) corresponding sensor(s) 108, 110, 112. Additionally, the nodes 102, 104, 106 include the corresponding data analysis circuitry 114, 116, 118.

The example sensors 108, 110, 112 of FIG. 1 are devices that sense and/or capture data related to the environment 100. For example, in the example of FIG. 1, the sensors 108, 110, 112 are cameras to obtain images to be able to track items (e.g., such as the tracked object 130). However, the sensors 108, 110, 112 can be any type of sensor that gathers any type of information. For example, the sensors 108, 110, 112 can be temperature sensors, pressure sensors, current sensors, voltage sensors, hall effect sensors, magnetic sensors, audio sensors, accelerometers, and/or any other type of sensor. As described above, the sensors 108, 110, 112 may be stationary or mobile. Additionally, each of the sensors 108, 110, 112 include characteristics. For example, the sensor 108 captures images at a first resolution, at a first frequency, with a first amount of flash, with a first amount of zoom, at a first angle, etc., while the sensor 110 captures images at a second resolution, at a second frequency, with a second amount of flash, with a second amount of zoom, as a second angle, etc. Some or all of the characteristics of the sensors 108, 110, 112 may be the same or different. The sensors 108, 110, 112 pass the sensed data to the corresponding data analysis circuitry 114, 116, 118.

The data analysis circuitries 114, 116, 118 of FIG. 1 process and/or analyze the sensed data from the corresponding sensor 108, 110, 112. For example, the data analysis circuitries 114, 116, 118 may implement one or more model(s) (e.g., an AI-based model) to generate classifications based on the sensed data. In some examples, the model(s) may be trained to perform object detection, object identification, object tracking, defect detection, etc. In some examples, the data analysis circuitries 114, 116, 118 implement the same model or different parts of one model. However, the data analysis circuitries 114, 116, 118 may implement different models. For example, if one of the nodes 102, 104, 106 include more available resources for processing than the other nodes, the data analysis circuitry of the more powerful node may implement a more robust or larger model than one of more of the other data analysis circuitries. The data analysis circuitry 114, 116, 118 forward the results of the analysis and/or the data from the corresponding sensors 108, 110, 112 to the system control circuitry 120 via the network 128. For example, the data analysis circuitry 114, 116, 118 can output data that includes a timestamp, a node identifier, a classification, information related to the classification, etc. The data may also include metadata that includes additional details related to the classification, an identifier (e.g., barcode) of a tracked object, a confidence rate of the classification, etc.

Although the example of FIG. 1 includes three nodes with sensor and data analysis circuitry, the environment 100 may include one or more sensors that are connected to (e.g., via a wired or wireless connection) data analysis circuitry in a single node or in the system control circuitry 120. For example, the sensors 108, 110 may transmit their respective sensed data to a single node that includes data analysis circuitry to analyze the data from both sensors and the data analysis circuitry 114 can send the analysis (also referred to as inference) of both sensors to the system control circuitry 120. In another example, the sensor 108 may send the sensed data (e.g., directly or via one or more devices) to one or more data analysis circuitries implemented in the system control circuitry 120.

The example system control circuitry 120 of FIG. 1 obtains information from the nodes 102, 104, 106 of the environment 100. For example, the system control circuitry 120 can obtain the sensed data from the sensors 108, 110, 112 and/or the analysis and/or classification results of the data analysis circuitries 114, 116, 118. The system control circuitry 120 stores the obtained information and clusters and/or groups data based on similarity. For example, the system control circuitry 120 may cluster data from the node 102 that includes a barcode of the tracked object 130 with data from the node 104 that also includes the barcode of the tracked object 130. In the example of FIG. 1, if the data from the node 106 does not include the barcode of the tracked object 130, the data from the node will not be included in the cluster of the data from the nodes 102, 104.

The system control circuitry 120 of FIG. 1 processes the analysis and/or classification results from the same cluster to determine if there are any conflicts. For example, if the node 102 classifies a defect in the tracked object 130 and the node 104 also classifies a defect in the tracked object 130 within a threshold amount of time, the system control circuitry 120 will determine that no conflict arises. However, if the node 102 classifies a defect in the tracked object 130 and the node 104 does not classify a defect in the tracked object 130 within a threshold amount of time, the system control circuitry 120 will determine that there is a conflict. After the system control circuitry 120, identifies a conflict between analysis and/or inference of clustered data, the system control circuitry 120 attempts to determine which node generated the correct analysis and which node generated the incorrect analysis.

In some examples, the system control circuitry 120 of FIG. 1 determines which node the correct analysis based on a validator node. A validator node is a node that has been designated a validator node based on the characteristics of the node and/or the previous analysis and/or inference of the node. For example, a node may be initially tagged as a validator node if the node implements a more robust model, if the node includes or is connected to a higher quality sensor, based on a particular position or location of the node and/or sensor, has and/or is connected to a high range sensor, etc. Additionally or alternatively, a node that has a trust (e.g., confidence) score above a threshold may be designated a validator node. For example, for each correct classification given by a node, the system control circuitry 120 can increase the trust score of the node. Additionally, for each incorrect classification given by a node, the system control circuitry 120 can decrease the trust score of the node. If the trust score is above a threshold, the system control circuitry 120 can promote a node to a validator node and if the trust score of a node drops below the threshold, the system control circuitry 120 can demote the node from a validator node to a regular node. The trust score(s) may be stored locally or remotely.

In some examples, if a validator node is not available in a cluster that includes conflicting information, the system control circuitry 120 may use the sensor data from the conflicting nodes and utilize data analysis circuitry from a validator node outside of the cluster to resolve the conflict. For example, the system control circuitry 120 may include data analysis circuitry or may transmit the sensor data from the conflicting nodes to another node that is a validator node to run a data analysis model to resolve the conflict. The validator node will provide the results to the system control circuitry 120. If the results still indicate that a conflict exists, the system control circuitry 120 may determine that both nodes are correct. For example, the node 102 may identify a defect, however, because of the angle of the node 104, the defect cannot be sensed by the sensor 110. Additionally or alternatively, the system control circuitry 120 can instruct the mobile validation unit 122 to move to a location corresponding to the conflicting node(s) and capture data via a locally implemented sensor. As further described below, the mobile validation unit 122 can analyze the results to resolve the conflict and send the results to the system control circuitry 120.

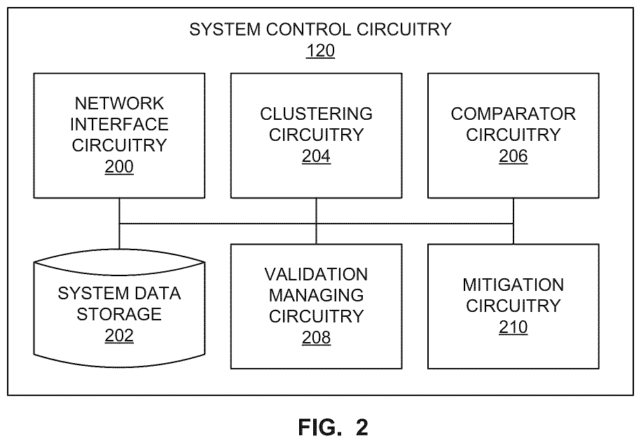

After the system control circuitry 120 of FIG. 1 resolves a conflict by determining which analysis is correct and which analysis is incorrect, the system control circuitry 120 performs mitigating actions. For example, the system control circuitry 120 can change the settings of the incorrect node (e.g., adjust the amount of flash, adjust the capture frequency, adjust the amount of zoom, etc.), change the settings of the environment (e.g., adjust the brightness of the lighting, turn light(s) on or off, etc.), power down the incorrect node (e.g., to conserve resources), retrain the model implemented by the incorrect node (e.g., to make the node more robust to different conditions), demote an incorrect node from a validator status, promote a correct node to a validator status, adjust the trust value of a node, etc. In some examples, the system control circuitry 120 may factor in external factors into the migration of an inaccurate node. For example, if an inaccurate node only generates inaccurate analysis if the lighting condition is low and/or during a particular time of day, week, month, etc., the system control circuitry 120 may power down the node based on the lighting conditions and/or based on the particular time of day, week, month, etc. The system control circuitry 120 is further described below in conjunction with FIG. 2.

The example mobile validation unit 122 of FIG. 1 may be a drone, a robotic device, and/or any other mobile device that is capable of moving to instructed locations, capturing sensed data, and/or processing the sensed data. The mobile validation unit 122 includes the example sensor 124 and the example data analysis circuitry 126. As described above, after a conflict occurs, the system control circuitry 120 may instruct the mobile validation unit 122 to move to the location(s) associated with the conflict and gathered images and/or other sensed data to determine which node(s) associated with a conflict is/are correct and which node(s) is/are incorrect. In response to instructions to move to a location, the mobile validation unit 122 moves to the instructed location and uses the sensor 124 to gather sensed data. After the sensed data is obtained, the data analysis circuitry 126 analyzes the sensed data to determine an analysis results. The mobile validation unit 122 transmits the analysis result and/or sensed data to the system control circuitry 120, so that the system control circuitry 120 can resolve the conflict. In some examples, the mobile validation unit 122 can obtain sensor data at the instructed location(s) and pass the sensed data to the system control circuitry 120 and the system control circuitry 120 can analyze the sensed data to resolve the conflict.

The network 128 of FIG. 1 is a system of interconnected systems exchanging data. The network 128 may be implemented using any type of public or private network such as, but not limited to, the Internet, a telephone network, a local area network (LAN), a cable network, and/or a wireless network. To enable communication via the network 128, the example nodes 102, 104, 105, the example system control circuitry 120, and the example mobile validation unit 122 include a communication interface that enables a connection to an Ethernet, a digital subscriber line (DSL), a telephone line, a coaxial cable, an optical fiber connection, or any wireless connection, etc. In some examples, the network 128, the example nodes 102, 104, 105, the example system control circuitry 120, and the example mobile validation unit 122 are connected via the network 128.

FIG. 2 is a block diagram of an example implementation of the system control circuitry 120 of FIG. 1. The system control circuitry 120 of FIG. 2 includes example network interface circuitry 200, example system data storage 202, example clustering circuitry 204, example comparator circuitry 206, example validation managing circuitry 208, and example mitigation circuitry 210.

The network interface circuitry 200 of FIG. 2 sends and receives data from other devices in the environment 100 of FIG. 1 via the network 128. For example, the network interface circuitry 200 obtains sensor data and/or analysis from the nodes 102, 104, 106 and/or the mobile validation unit 122. Additionally, the network interface circuitry 200 can send out instructions and/or requests to the nodes 102, 104, 106, the mobile validation unit 122, and/or any other component in the environment 100. For example, the network interface circuitry 200 can send instructions to one of the nodes 102, 104, 106 to adjust settings and/or power down, to the mobile validation unit 122 to move to a location to gather and analysis data, and/or to any control circuitry in the environment 100 (e.g., to adjust settings of the environment such, as lighting).

The system data storage 202 of FIG. 2 stores the data and/or corresponding metadata from the nodes 102, 104, 106. For example, after the nodes 102, 104, 106 transmit an analysis based on sense data, the system data storage 202 stores the data and/or corresponding metadata. In some examples, the data includes the sensed data from the corresponding sensor.

The clustering circuitry 204 of FIG. 2 clusters the system data storage 202 based on similarity. In some examples, the clustering circuitry 204 may cluster data based on a similarity in an identifier in the metadata (e.g., whether the identifiers match or mismatch). For example, if the metadata includes a barcode of a tracked object, the clustering circuitry 204 can cluster the data based on the barcode. The clustering circuitry 204 may cluster data based on any one or more similarities in the data (e.g., location, timestamp, node identifier, etc.).

The example comparator circuitry 206 of FIG. 2 compares data from the cluster(s) of data for conflicts. For example, the comparator circuitry 206 can process the data of a cluster to identify if there is any conflict in classifications within the cluster (e.g., data from one node identifies a defect and data from another node in the same cluster does not identify a defect). If the comparator circuitry 206 determines that a conflict exists, the validation managing circuitry 208 performs actions to determine which data in a cluster is accurate and which data is inaccurate, as further described below.

The validation managing circuitry 208 of FIG. 2 validates classification results based on the output of the comparator circuitry 206. For example, if the comparator circuitry 206 determines that a conflict between data in a cluster does not exist, the validation managing circuitry 208 validates the analysis and/or inference of the data in the cluster. If the comparator circuitry 206 determines that a conflict exists between data in a cluster, the validation managing circuitry 208 determines which classification(s) is/are correct and which classification(s) is/are incorrect. The validation managing circuitry 208 validates the correct analysis and discards the incorrect analysis. To determine which data is accurate and which data is inaccurate, the validation managing circuitry 208 can use validator node(s) and/or the mobile validation unit 122. For example, if the cluster of data includes data from a validator node and there is overlap in area between the validator node and a conflicting node (e.g., the sensors of the two nodes captured the data based on overlapping areas), the validation managing circuitry 208, the validation managing circuitry 208 validates the analysis and/or inference of the validator node and discards the analysis and/or inference of the conflicting node.

In some examples, if the cluster of data does not include data from a validator node or if the cluster of data corresponds to locations that do not overlap by a threshold amount, the validation managing circuitry 208 of FIG. 2 may output the sensor data corresponding to the cluster to a validator node outside of the cluster to process the conflicting data to determine whether or not the validator node agrees with one or both of the analysis. In some examples, if the cluster data does not include data from a validator node or if the cluster data corresponds to locations that do not overlap by a threshold amount, the validation managing circuitry 208 may instruction the mobile validation unit 122 to move to one or more locations near the nodes that generated the conflicting results. In this manner, the mobile validation unit 122 can use the sensor 124 to sense data at or near the locations where the conflicting data was generated and process the sensed data to determine whether the analysis and/or inference of the conflicting nodes is accurate or inaccurate. The results of the mobile validation is sent (e.g., transmitted) back to the system control circuitry 120. Thus, the validation managing circuitry 208 can compare the analysis from the nodes to the analysis from the mobile validation unit 122 to determine if the analysis and/or inference of the nodes are accurate or inaccurate. As described above, the validation managing circuitry 208 validates the accurate data and discards the inaccurate data. The validation managing circuitry 208 can output the validated results to other circuitry (e.g., other processing circuitry) of the system control circuitry 120 for further processing and/or actions (e.g., to alert a user of a detected defect).

The example mitigation circuitry 210 of FIG. 1 performs one or more mitigation actions based on the validation results of the validation managing circuitry 208. For example, the mitigation circuitry 210 may increase trust scores for nodes that produced data that was validated and may decrease trust score of nodes that produced data that was inaccurate and discarded. Additionally, if the trust score of a particular node is raised to above a threshold score, the mitigation circuitry 210 can promote the node to a validator node. Additionally, if the trust score of a particular node is lowered to below a threshold amount, the mitigation circuitry 210 can demote the node from a validator node to a regular node. The mitigation circuitry 210 can also change the characteristics of the environment and/or one or more of the node(s) 102, 104, 106 based on the validation results. For example, if a conflict exists between the two nodes 102, 104 in the same area, the mitigation circuitry 210 can adjust the lighting in the area. In another example, the mitigation circuitry 210 can adjust configurations of a sensor that resulted in inaccurate analysis. For example, the mitigation circuitry 210 can adjust the amount or duration of flash, the amount of zoom, the resolution of the sensor, the angle of the sensor, the movement of the sensor, the location of the sensor, the frequency of image capture, processing configuration of the captured images, etc. If the sensor is an audio sensor, the mitigation circuitry 210 can adjust the settings of the audio sampler such as the gain of gain of the sensor, the filtering of the sensor, etc. In some examples, the mitigation circuitry 210 can power down a node that corresponds to a threshold number of inaccurate results and/or that has a trust score lower than a threshold. In some examples, the mitigation circuitry 210 can trigger the retraining of a model implemented by a node in response to one or more inaccurate analysis from the node. As described above, the mitigation circuitry 210 may utilize contextual data to perform mitigation actions. For example, the mitigation circuitry 210 can determine that a node has inaccurate analysis at particular times. In such an example, the mitigation circuitry 210 may power down the node during the times if the node has historically had inaccurate analysis and power up the node during times if the node has historically been accurate. The mitigation circuitry 210 can transmit mitigation instructions to nodes within the environment 100 via the network 128 using the network interface 200. Additionally, the mitigation circuitry 210 can cause the sensor(s) 102, 104, 106, to capture additional data, rerun the sensed data in the model implemented by the data analysis circuitry, transmit the sensed data to another node for processing, re-routing the tracked object 130 to another area, cause the mobile validation unit 122 to obtain additional sensor data and/or analyze the data from the sensor and/or the additional sensor data, etc.

While an example manner of implementing the system control circuitry 120 of FIG. 1 is illustrated in FIG. 2, one or more of the elements, processes, and/or devices illustrated in FIG. 2 may be combined, divided, re-arranged, omitted, eliminated, and/or implemented in any other way. Further, the network interface circuitry 200, the system data storage 202, the clustering circuitry 204, the comparator circuitry 206, the validation managing circuitry 208, the mitigation circuitry 210, and/or, more generally, the system control circuitry 120 of FIG. 2, may be implemented by hardware alone or by hardware in combination with software and/or firmware. Thus, for example, any of the network interface circuitry 200, the system data storage 202, the clustering circuitry 204, the comparator circuitry 206, the validation managing circuitry 208, the mitigation circuitry 210, and/or, more generally, the system control circuitry 120 of FIG. 2, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the system control circuitry 120 of FIG. 2 may include one or more elements, processes, and/or devices in addition to, or instead of, those illustrated in FIGS. 1 and/or 2, and/or may include more than one of any or all of the illustrated elements, processes, and devices.

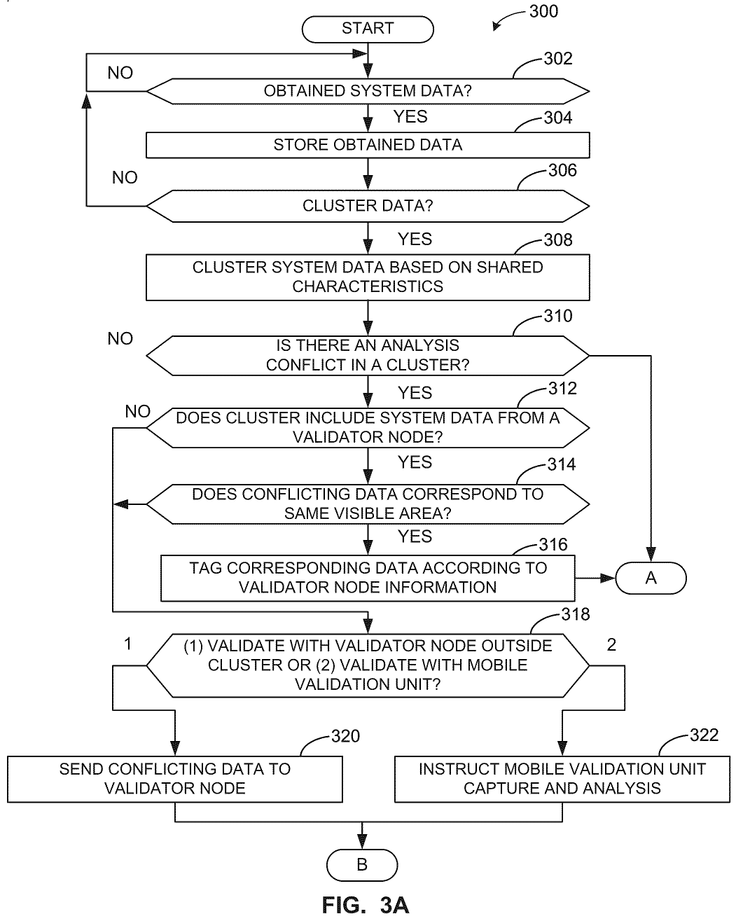

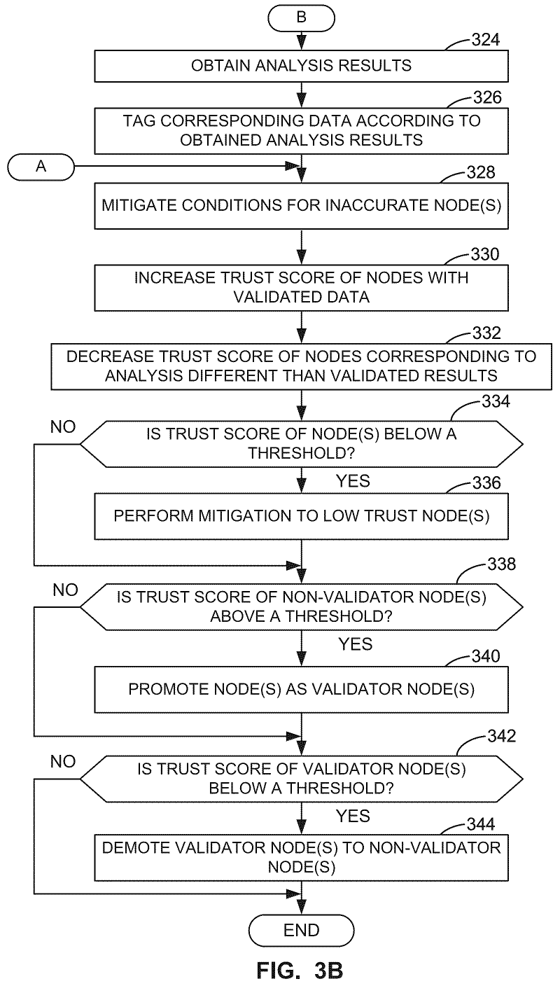

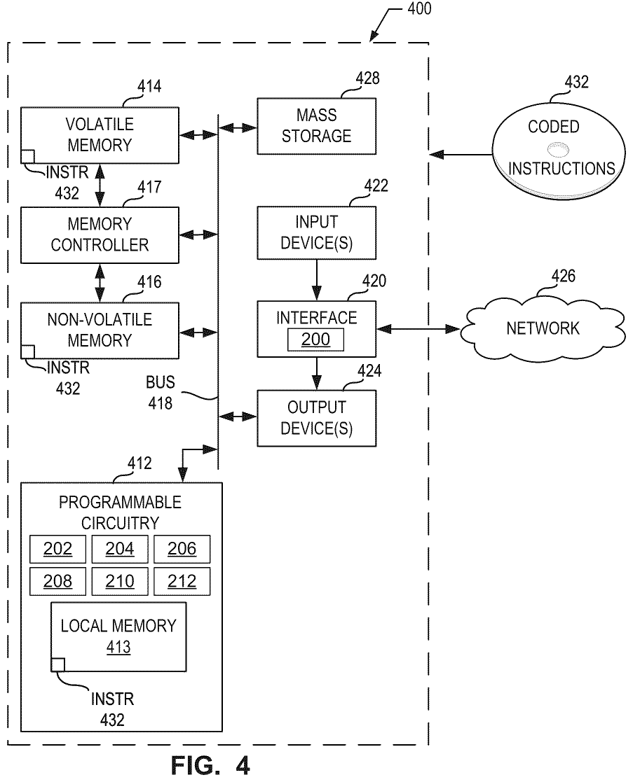

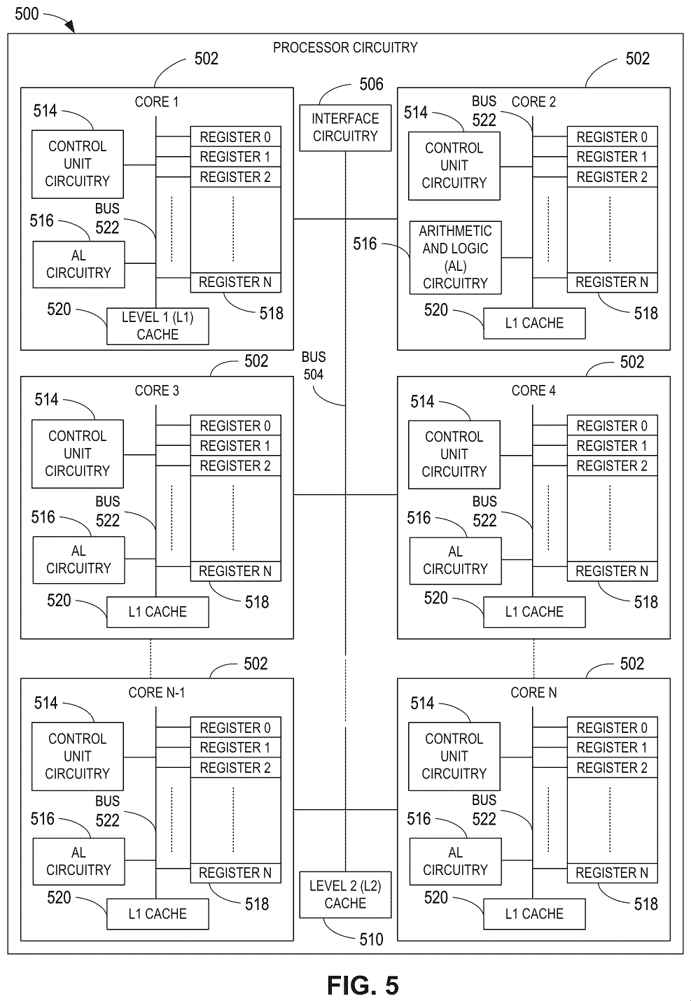

Flowchart(s) representative of example machine readable instructions, which may be executed by programmable circuitry to implement and/or instantiate the system control circuitry 120 of FIG. 2 representative of example operations which may be performed by programmable circuitry to implement and/or instantiate the system control circuitry 120 of FIG. 2, is shown in FIGS. 3A-3B. The machine readable instructions may be one or more executable programs or portion(s) of one or more executable programs for execution by programmable circuitry such as the programmable circuitry 412 shown in the example processor platform 400 discussed below in connection with FIG. 4 and/or may be one or more function(s) or portion(s) of functions to be performed by the example programmable circuitry (e.g., an FPGA) discussed below in connection with FIGS. 5 and/or 6. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 3A-3B, many other methods of implementing the system control circuitry 120 of FIG. 2 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), a microservice, etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, Go Lang, etc.

As mentioned above, the example operations of FIGS. 3A-3B may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or operations, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or operations, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

Descriptors “first,” “second,” “third,” etc. are used herein when identifying multiple elements or components which may be referred to separately. Unless otherwise specified or understood based on their context of use, such descriptors are not intended to impute any meaning of priority or ordering in time but merely as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

FIGS. 3A-3B includes a flowchart representative of example machine readable instructions and/or example operations 300 that may be executed, instantiated, and/or performed by programmable circuitry(ies) to facilitate collaborative learning in the multi-sensor environment 100 of FIG. 1. For example, the example operations 300 may be executed, instantiated, and/or performed by the system control circuitry 120 of FIG. 2. The example machine-readable instructions and/or the example operations 300 of FIGS. 3A-3B begin at block 302, at which the network interface circuitry 200 obtains or does not obtain system data. The system data can be data and/or metadata that is collected and/or analyzed by the nodes 102, 104, 106 in the environment 100. The system data may include the sensed data, analysis and/or inference of the sensed data, and/or data related to the sensing and/or analysis and/or inference of the sensed data.

If the network interface 200 does not obtain system data (block 302: NO), control returns to block 302 until system data is obtained. If the network interface 200 obtains system data (block 302: YES), the system data storage 202 stores the system data (bock 304). At block 306, the clustering circuitry 204 determines whether to cluster the data in the system data storage 202. The clustering circuitry 204 may cluster the data periodically, aperiodically, and/or based on a trigger (e.g., an instruction from a user, based on a threshold number of system data being obtained, etc.). If the clustering circuitry 204 determines that the stored data should not yet be clustered (block 306: NO), control returns to block 302. If the clustering circuitry 204 determines that the stored data should be clustered (block 306: YES), the clustering circuitry 204 clusters the system data based on a shared characteristic (block 308). For example, the clustering circuitry 204 can cluster the system data based on one or more of a same or similar identifier of the tracked object (e.g., all data corresponding to a particular tracked object is clustered together), a same or similar location, a same or similar duration of time, etc.

At block 310, the example comparator 206 determines if there is an analysis conflict in a cluster. For example, if the classification in first data in a cluster from the node 104 is different than the classification in second data in the cluster from node 106, the comparator 206 determines that there is an analysis conflict in the cluster. If the comparator 206 determines that there is not an analysis conflict in the cluster (block 310: NO), control continues to block 328 of FIG. 3B. If the comparator 206 determines that there is an analysis conflict in the cluster (block 310: YES), the validation managing circuitry 208 determines if the cluster includes system data from a validated node (block 312).

If the validation managing circuitry 208 determines that the cluster does not include system data from a validator node (block 312: NO), control continues to block 318, as further described below. If the validation managing circuitry 208 determines that the cluster includes system data from the validator node (block 312: YES), the validation managing circuitry 208 determines if the conflicting data correspond to the same visible area (block 314). The visible area is the area of the environment 100 that the sensor senses while sensing data. For example, the system data and/or metadata from the nodes may include information related to the angle(s) of the sensor while sensing the data used for the analysis. In some examples, the angle or position of capture may be determined after the sensor is placed into position and the angle and/or position information may be stored locally. In this manner, the validation managing circuitry 208 can determine whether the conflicting data corresponds to the same visible area based on the system data, metadata, and/or the locally stored data that corresponds to the positioning of the sensor.

If the validation managing circuitry 208 determines that the conflicting data does not correspond to the same visible area (block 314: NO), control continues to block 318, as further described below. If the validation managing circuitry 208 determines that the conflicting data corresponds to the same visible area (block 316: YES), the validation managing circuitry 208 tags the corresponding node data according to the validator node information (block 316). For example, if a first validator node identifies a defect for a tracked object based on sensor data and a second non-validator node does not identify the defect for the tracked object based on sensor data, the validation managing circuitry 208 validates the defect for the tracked object and discards the no-defect analysis from the non-validator node.

At block 318, the validation managing circuitry 208 determines whether to (1) validate data corresponding to a conflict with a validator node outside of the cluster or (2) validate data corresponding to a conflict using the mobile validation unit 122 of FIG. 1. The validation managing circuitry 208 may select (1) or (2) based on user and/or manufacturer preferences, based on availability of the mobile validation unit and/or a validator node, etc. If the validation managing circuitry 208 determines to validate data based on the validator node outside of the cluster (block 318:1), the validation managing circuitry 208 sends the conflicting data (e.g., the sensed data from the sensors that resulted in a conflict) to a validator node outside of the cluster (block 320). In this manner, the validator node can analyze the data from the conflicting nodes and output analysis for the different data. If the conflict still exists, then there may be a problem with the angle, the environment, and/or the characteristics of the sensor, rather than the model used for the analysis. If the conflict no longer exists, then there may be a problem with the model of the node that generated the inaccurate results.

If the validation managing circuitry 208 determines to validate data based on the mobile validation unit 122 (block 318:2), the validation managing circuitry 208 sends the instructions to the mobile validation unit 122 to capture and analyze data at or near the location(s) of the nodes that generated the conflicting data (block 320). In this manner, the sensor 124 of the mobile validation unit 122 can capture data at or near the nodes and the data analysis circuitry 126 of the mobile validation unit 122 can analyze the data corresponding to the locations of each node in the cluster. If the conflict still exists, then there may be a problem with the angle, the environment, and/or the characteristics of the sensor, rather than the model used for the analysis. If the conflict no longer exists, then there may be a problem with the model of the node that generated the inaccurate results.

At block 324 of FIG. 3B, the network interface circuitry 200 obtains the analysis results (e.g., from the validator node or the mobile validation unit 122). At block 326, the validation managing circuitry 208 tags the data that corresponds to the analysis of the validator node and/or mobile validation unit 122 as valid and discards the data from the nodes that does not correspond to the analysis of the validator node and/or mobile validation unit 122. At block 328, the mitigation circuitry 210 mitigates conditions for the inaccurate node(s). For example, the mitigation circuitry 210 can adjust the lighting near the inaccurate node, adjust the settings of the sensor corresponding to the inaccurate node, etc. At block 330, the example mitigation circuitry 210 of FIG. 2 increases the trust score of the nodes with data that has been validated. For example, if system data for a node was validated as corresponding to accurate analysis, the migration circuitry 210 can increase the trust score of the node. At block 332, the example mitigation circuitry 210 of FIG. 2 decreases the trust score of the nodes with analysis different than the validated results (e.g., inaccurate analysis).

At block 334, the mitigation circuitry 210 determines if the rust score of one or more node(s) is below a threshold. If the mitigation circuitry 210 determines that the trust score of one or more node(s) is not below a threshold (block 334: NO), control continues to block 338. If the mitigation circuitry 210 determines that the trust score of the one or more node(s) is below a threshold (block 334: YES), the mitigation circuitry 210 performs mitigation actions to the low trust node(s) (e.g., nodes with trust scores below the threshold) (block 226). For example, the mitigation circuitry 210 may power down the nodes, retrain the models implemented by the nodes, flag the nodes for repair and/or upgrades, etc.

At block 338, the mitigation circuitry 210 determines if the trust score of any of the non-validator node(s) is above a threshold. If the mitigation circuitry 210 determines that the trust score of any of the non-validator nodes is not above a threshold (block 338: NO), control continues to block 342. If the mitigation circuitry 210 determines that the trust score of any of the non-validator nodes is above a threshold (block 338: YES), the mitigation circuitry 210 promotes the non-validator node(s) that have a trust score above the threshold to validator node(s) (block 340). At block 342, the example mitigation circuitry 210 determines if the trust score of any of the validator node(s) is below a threshold. If the mitigation circuitry 210 determines that the trust score of any of the validator nodes(s) is not below a threshold (block 342: NO), the instructions end. If the mitigation circuitry 210 determines that the trust score of at least one node is blow the threshold (block 342: YES), the mitigation circuitry 210 demotes the validator node(s) with a trust score below the threshold to a non-validator node. In some examples, there may be two or more thresholds and/or two or more levels of validator node (e.g., high level validator, low level validator, non-validator, low trust, etc.). After block 344, the instructions end.

FIG. 4 is a block diagram of an example programmable circuitry platform 400 structured to execute and/or instantiate the example machine-readable instructions and/or the example operations of FIGS. 3A-3B to implement the system control circuitry 120 of FIG. 2. The programmable circuitry platform 400 can be, for example, a server, a personal computer, a workstation, a self-learning machine (e.g., a neural network), or any other type of computing and/or electronic device.

The programmable circuitry platform 400 of the illustrated example includes programmable circuitry 412. The programmable circuitry 412 of the illustrated example is hardware. For example, the programmable circuitry 412 can be implemented by one or more integrated circuits, logic circuits, FPGAs, microprocessors, CPUs, GPUs, DSPs, and/or microcontrollers from any desired family or manufacturer. The programmable circuitry 412 may be implemented by one or more semiconductor based (e.g., silicon based) devices. In this example, the programmable circuitry 412 implements the network interface circuitry 200, the clustering circuitry 204, the comparator circuitry 206, the validation managing circuitry 208, and/or the mitigation circuitry 210 of FIG. 2.

The programmable circuitry 412 of the illustrated example includes a local memory 413 (e.g., a cache, registers, etc.). The programmable circuitry 412 of the illustrated example is in communication with main memory 414, 416, which includes a volatile memory 414 and a non-volatile memory 416, by a bus 418. The volatile memory 414 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 416 may be implemented by flash memory and/or any other desired type of memory device. Access to the main memory 414, 416 of the illustrated example is controlled by a memory controller 417. In some examples, the memory controller 417 may be implemented by one or more integrated circuits, logic circuits, microcontrollers from any desired family or manufacturer, or any other type of circuitry to manage the flow of data going to and from the main memory 414, 416. Any one or more of the memories 413, 414, 416 may implement the system data storage 220 of FIG. 2.

The programmable circuitry platform 400 of the illustrated example also includes interface circuitry 420. The interface circuitry 420 may be implemented by hardware in accordance with any type of interface standard, such as an Ethernet interface, a universal serial bus (USB) interface, a Bluetooth® interface, a near field communication (NFC) interface, a compute express link (CXL) interface and/or a Peripheral Component Interconnect Express (PCIe) interface. In this example, the interface circuitry 420 implements the network interface circuitry 200 of FIG. 2.

In the illustrated example, one or more input devices 422 are connected to the interface circuitry 420. The input device(s) 422 permit(s) a user (e.g., a human user, a machine user, etc.) to enter data and/or commands into the programmable circuitry 412. The input device(s) 422 can be implemented by, for example, a keyboard, a button, a mouse, and/or a touchscreen.

One or more output devices 424 are also connected to the interface circuitry 420 of the illustrated example. The output device(s) 424 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), and/or speaker. The interface circuitry 420 of the illustrated example, thus, typically includes a graphics driver card, a graphics driver chip, and/or graphics processor circuitry such as a GPU.

The interface circuitry 420 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 426. The communication can be by, for example, an Ethernet connection, a digital subscriber line (DSL) connection, a telephone line connection, a coaxial cable system, an optical fiber connection, a satellite system, a beyond-line-of-sight wireless system, a line-of-sight wireless system, a cellular telephone system, an optical connection, etc.

The programmable circuitry platform 400 of the illustrated example also includes one or more mass storage discs or devices 428 to store firmware, software, and/or data. Examples of such mass storage discs or devices 428 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 432, which may be implemented by the machine readable instructions of FIGS. 3A-3B, may be stored in the mass storage device 428, in the volatile memory 414, in the non-volatile memory 416, and/or on at least one non-transitory computer readable storage medium such as a CD or DVD which may be removable.

FIG. 5 is a block diagram of an example implementation of the programmable circuitry 412 of FIG. 4. In this example, the programmable circuitry 412 of FIG. 4 is implemented by a microprocessor 500. For example, the microprocessor 500 may be a general-purpose microprocessor (e.g., general-purpose microprocessor circuitry). The microprocessor 500 executes some or all of the machine-readable instructions of the flowcharts of FIGS. 3A-3B to effectively instantiate the circuitry of FIGS. 1 and/or 2 as logic circuits to perform operations corresponding to those machine readable instructions. In some such examples, the circuitry of FIGS. 5 and/or 6 is instantiated by the hardware circuits of the microprocessor 500 in combination with the machine-readable instructions. For example, the microprocessor 500 may be implemented by multi-core hardware circuitry such as a CPU, a DSP, a GPU, an XPU, etc. Although it may include any number of example cores 502 (e.g., 1 core), the microprocessor 500 of this example is a multi-core semiconductor device including N cores. The cores 502 of the microprocessor 500 may operate independently or may cooperate to execute machine readable instructions. For example, machine code corresponding to a firmware program, an embedded software program, or a software program may be executed by one of the cores 502 or may be executed by multiple ones of the cores 502 at the same or different times. In some examples, the machine code corresponding to the firmware program, the embedded software program, or the software program is split into threads and executed in parallel by two or more of the cores 502. The software program may correspond to a portion or all of the machine readable instructions and/or operations represented by the flowchart of FIGS. 3A-3B.

The cores 502 may communicate by a first example bus 504. In some examples, the first bus 504 may be implemented by a communication bus to effectuate communication associated with one(s) of the cores 502. For example, the first bus 504 may be implemented by at least one of an Inter-Integrated Circuit (I2C) bus, a Serial Peripheral Interface (SPI) bus, a PCI bus, or a PCIe bus. Additionally or alternatively, the first bus 504 may be implemented by any other type of computing or electrical bus. The cores 502 may obtain data, instructions, and/or signals from one or more external devices by example interface circuitry 506. The cores 502 may output data, instructions, and/or signals to the one or more external devices by the interface circuitry 506. Although the cores 502 of this example include example local memory 520 (e.g., Level 1 (L1) cache that may be split into an L1 data cache and an L1 instruction cache), the microprocessor 500 also includes example shared memory 510 that may be shared by the cores (e.g., Level 2 (L2 cache)) for high-speed access to data and/or instructions. However, in some example the L2 cache is connected to each core 502 and the shared memory 510 is implemented by level 3 (L3) cache for high-speed access to data and/or instructions. Data and/or instructions may be transferred (e.g., shared) by writing to and/or reading from the shared memory 510. The local memory 520 of each of the cores 502 and the shared memory 510 may be part of a hierarchy of storage devices including multiple levels of cache memory and the main memory (e.g., the main memory 414, 416 of FIG. 4). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 502 may be referred to as a CPU, DSP, GPU, etc., or any other type of hardware circuitry. Each core 502 includes control unit circuitry 514, arithmetic and logic (AL) circuitry (sometimes referred to as an ALU) 516, a plurality of registers 518, the local memory 520, and a second example bus 522. Other structures may be present. For example, each core 502 may include vector unit circuitry, single instruction multiple data (SIMD) unit circuitry, load/store unit (LSU) circuitry, branch/jump unit circuitry, floating-point unit (FPU) circuitry, etc. The control unit circuitry 514 includes semiconductor-based circuits structured to control (e.g., coordinate) data movement within the corresponding core 502. The AL circuitry 516 includes semiconductor-based circuits structured to perform one or more mathematic and/or logic operations on the data within the corresponding core 502. The AL circuitry 516 of some examples performs integer based operations. In other examples, the AL circuitry 516 also performs floating-point operations. In yet other examples, the AL circuitry 516 may include first AL circuitry that performs integer-based operations and second AL circuitry that performs floating-point operations. In some examples, the AL circuitry 516 may be referred to as an Arithmetic Logic Unit (ALU).

The registers 518 are semiconductor-based structures to store data and/or instructions such as results of one or more of the operations performed by the AL circuitry 516 of the corresponding core 502. For example, the registers 518 may include vector register(s), SIMD register(s), general-purpose register(s), flag register(s), segment register(s), machine-specific register(s), instruction pointer register(s), control register(s), debug register(s), memory management register(s), machine check register(s), etc. The registers 518 may be arranged in a bank as shown in FIG. 5. Alternatively, the registers 518 may be organized in any other arrangement, format, or structure, such as by being distributed throughout the core 502 to shorten access time. The second bus 522 may be implemented by at least one of an I2C bus, a SPI bus, a PCI bus, or a PCIe bus.

Each core 502 and/or, more generally, the microprocessor 500 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 500 is a semiconductor device fabricated to include many transistors interconnected to implement the structures described above in one or more integrated circuits (ICs) contained in one or more packages.

The microprocessor 500 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 500, in the same chip package as the microprocessor 500 and/or in one or more separate packages from the microprocessor 500.

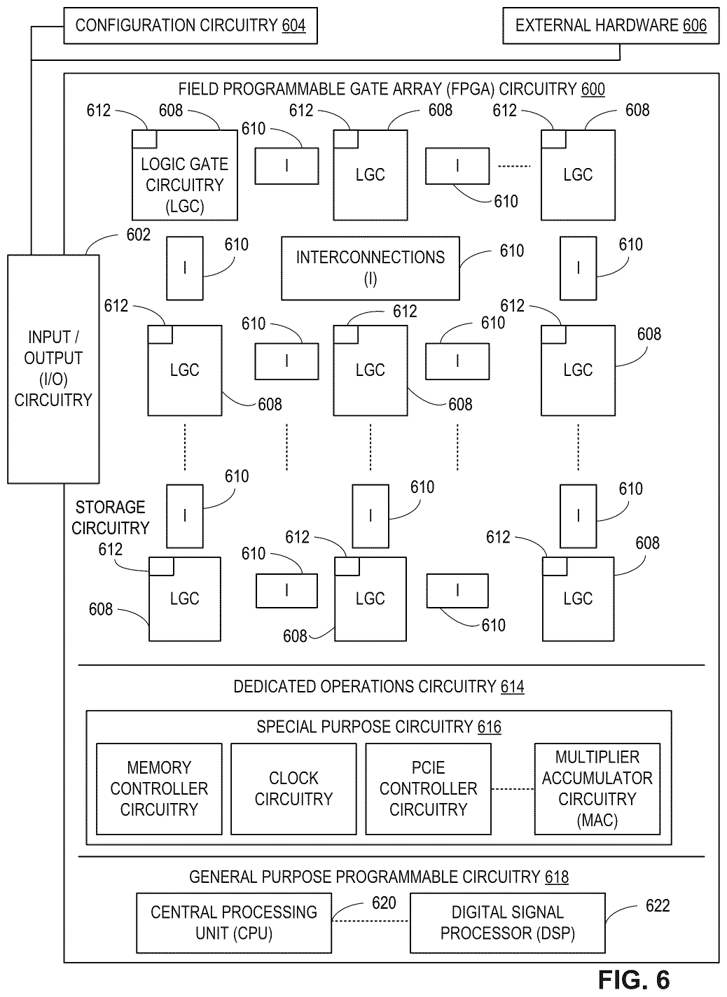

FIG. 6 is a block diagram of another example implementation of the programmable circuitry 412 of FIG. 4. In this example, the programmable circuitry 412 is implemented by FPGA circuitry 600. For example, the FPGA circuitry 600 may be implemented by an FPGA. The FPGA circuitry 600 can be used, for example, to perform operations that could otherwise be performed by the example microprocessor 500 of FIG. 5 executing corresponding machine readable instructions. However, once configured, the FPGA circuitry 600 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 500 of FIG. 5 described above (which is a general purpose device that may be programmed to execute some or all of the machine readable instructions represented by the flowchart(s) of FIGS. 3A-3B but whose interconnections and logic circuitry are fixed once fabricated), the FPGA circuitry 600 of the example of FIG. 6 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 3A-3B. In particular, the FPGA circuitry 600 may be thought of as an array of logic gates, interconnections, and switches. The switches can be programmed to change how the logic gates are interconnected by the interconnections, effectively forming one or more dedicated logic circuits (unless and until the FPGA circuitry 600 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 3A-3B. As such, the FPGA circuitry 600 may be configured and/or structured to effectively instantiate some or all of the operations/functions corresponding to the machine readable instructions of the flowchart(s) of FIGS. 3A-3B as dedicated logic circuits to perform the operations/functions corresponding to those software instructions in a dedicated manner analogous to an ASIC. Therefore, the FPGA circuitry 600 may perform the operations/functions corresponding to the some or all of the machine readable instructions of FIGS. 3A-3B faster than the general-purpose microprocessor can execute the same.

In the example of FIG. 6, the FPGA circuitry 600 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 600 of FIG. 6 may access and/or load the binary file to cause the FPGA circuitry 600 of FIG. 6 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 600 of FIG. 6 to cause configuration and/or structuring of the FPGA circuitry 600 of FIG. 6, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 600 of FIG. 6 may access and/or load the binary file to cause the FPGA circuitry 600 of FIG. 6 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 600 of FIG. 6 to cause configuration and/or structuring of the FPGA circuitry 600 of FIG. 6, or portion(s) thereof.

The FPGA circuitry 600 of FIG. 6, includes example input/output (I/O) circuitry 602 to obtain and/or output data to/from example configuration circuitry 604 and/or external hardware 606. For example, the configuration circuitry 604 may be implemented by interface circuitry that may obtain a binary file, which may be implemented by a bit stream, data, and/or machine-readable instructions, to configure the FPGA circuitry 600, or portion(s) thereof. In some such examples, the configuration circuitry 604 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 606 may be implemented by external hardware circuitry. For example, the external hardware 606 may be implemented by the microprocessor 500 of FIG. 5.

The FPGA circuitry 600 also includes an array of example logic gate circuitry 608, a plurality of example configurable interconnections 610, and example storage circuitry 612. The logic gate circuitry 608 and the configurable interconnections 610 are configurable to instantiate one or more operations/functions that may correspond to at least some of the machine readable instructions of FIGS. 3A-3B and/or other desired operations. The logic gate circuitry 608 shown in FIG. 6 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 608 to enable configuration of the electrical structures and/or the logic gates to form circuits to perform desired operations/functions. The logic gate circuitry 608 may include other electrical structures such as look-up tables (LUTs), registers (e.g., flip-flops or latches), multiplexers, etc.

The configurable interconnections 610 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 608 to program desired logic circuits.

The storage circuitry 612 of the illustrated example is structured to store result(s) of the one or more of the operations performed by corresponding logic gates. The storage circuitry 612 may be implemented by registers or the like. In the illustrated example, the storage circuitry 612 is distributed amongst the logic gate circuitry 608 to facilitate access and increase execution speed.

The example FPGA circuitry 600 of FIG. 6 also includes example dedicated operations circuitry 614. In this example, the dedicated operations circuitry 614 includes special purpose circuitry 616 that may be invoked to implement commonly used functions to avoid the need to program those functions in the field. Examples of such special purpose circuitry 616 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 600 may also include example general purpose programmable circuitry 618 such as an example CPU 620 and/or an example DSP 622. Other general purpose programmable circuitry 618 may additionally or alternatively be present such as a GPU, an XPU, etc., that can be programmed to perform other operations.

Although FIGS. 5 and 6 illustrate two example implementations of the programmable circuitry 412 of FIG. 4, many other approaches are contemplated. For example, FPGA circuitry may include an on-board CPU, such as one or more of the example CPU 620 of FIG. 5. Therefore, the programmable circuitry 412 of FIG. 4 may additionally be implemented by combining at least the example microprocessor 500 of FIG. 5 and the example FPGA circuitry 600 of FIG. 6. In some such hybrid examples, one or more cores 502 of FIG. 5 may execute a first portion of the machine readable instructions represented by the flowchart(s) of FIGS. 3A-3B to perform first operation(s)/function(s), the FPGA circuitry 600 of FIG. 6 may be configured and/or structured to perform second operation(s)/function(s) corresponding to a second portion of the machine readable instructions represented by the flowcharts of FIGS. 3A-3B, and/or an ASIC may be configured and/or structured to perform third operation(s)/function(s) corresponding to a third portion of the machine readable instructions represented by the flowcharts of FIGS. 3A-3B.

It should be understood that some or all of the circuitry of FIGS. 5 and/or 6 may, thus, be instantiated at the same or different times. For example, same and/or different portion(s) of the microprocessor 500 of FIG. 5 may be programmed to execute portion(s) of machine-readable instructions at the same and/or different times. In some examples, same and/or different portion(s) of the FPGA circuitry 600 of FIG. 6 may be configured and/or structured to perform operations/functions corresponding to portion(s) of machine-readable instructions at the same and/or different times.

In some examples, some or all of the circuitry of FIGS. 5 and/or 6 may be instantiated, for example, in one or more threads executing concurrently and/or in series. For example, the microprocessor 500 of FIG. 5 may execute machine readable instructions in one or more threads executing concurrently and/or in series. In some examples, the FPGA circuitry 600 of FIG. 6 may be configured and/or structured to carry out operations/functions concurrently and/or in series. Moreover, in some examples, some or all of the processor circuitry 412 of FIGS. 5 and/or 6 may be implemented within one or more virtual machines and/or virtual execution environments executing on the microprocessor 500 of FIG. 5.

In some examples, the programmable circuitry 412 of FIG. 4 may be in one or more packages. For example, the microprocessor 500 of FIG. 5 and/or the FPGA circuitry 600 of FIG. 6 may be in one or more packages. In some examples, an XPU may be implemented by the programmable circuitry 412 of FIGS. 4, which may be in one or more packages. For example, the XPU may include a CPU (e.g., the microprocessor 500 of FIG. 5, the CPU 620 of FIG. 6, etc.) in one package, a DSP (e.g., the DSP 622 of FIG. 6) in another package, a GPU in yet another package, and an FPGA (e.g., the FPGA circuitry 600 of FIG. 6) in still yet another package.

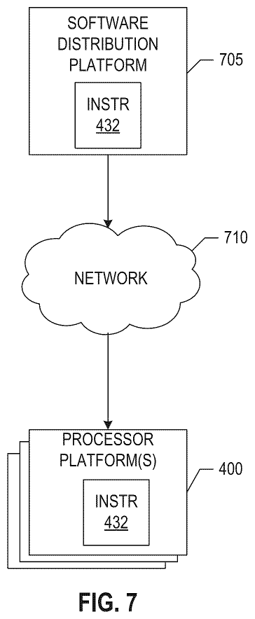

A block diagram illustrating an example software distribution platform 705 to distribute software such as the example machine readable instructions 432 of FIG. 4 to other hardware devices (e.g., hardware devices owned and/or operated by third parties from the owner and/or operator of the software distribution platform) is illustrated in FIG. 7. The example software distribution platform 705 may be implemented by any computer server, data facility, cloud service, etc., capable of storing and transmitting software to other computing devices. The third parties may be customers of the entity owning and/or operating the software distribution platform 705. For example, the entity that owns and/or operates the software distribution platform 705 may be a developer, a seller, and/or a licensor of software such as the example machine readable instructions 432 of FIG. 4. The third parties may be consumers, users, retailers, OEMs, etc., who purchase and/or license the software for use and/or re-sale and/or sub-licensing. In the illustrated example, the software distribution platform 705 includes one or more servers and one or more storage devices. The storage devices store the machine readable instructions 432, which may correspond to the example machine readable instructions of FIGS. 3A-3B, as described above. The one or more servers of the example software distribution platform 705 are in communication with an example network 710, which may correspond to the network 128 of FIG. 1. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 432 from the software distribution platform 705. For example, the software, which may correspond to the example machine readable instructions of FIGS. 3A-3B, may be downloaded to the example programmable circuitry platform 400 which is to execute the machine readable instructions 432 to implement the processor circuitry 412. In some examples, one or more servers of the software distribution platform 705 periodically offer, transmit, and/or force updates to the software (e.g., the example machine readable instructions 432 of FIG. 4) to ensure improvements, patches, updates, etc., are distributed and applied to the software at the end user devices. Although referred to as software above, the distributed “software” could alternatively be firmware.

Example methods, apparatus, systems, and articles of manufacture to facilitate collaborative learning in a multi-sensor environment are disclosed herein. Further examples and combinations thereof include the following: Example 1 includes a non-transitory computer readable medium comprising instructions to cause at least one programmable circuit to after determining that first data corresponding to a first sensor from a first device conflicts with second data corresponding to a second sensor from a second device validate the first device based on third data from a validated device, and mitigate the second device based on the third data.

Example 2 includes the non-transitory computer readable medium of example 1, wherein the first data is analysis of fourth data obtained from the first sensor and the third data is analysis of fifth data obtained from the validated device, the instructions to cause one of the at least one programmable circuit to validate the first device by determining that the first data from the first device matches the third data from the validated device.

Example 3 includes the non-transitory computer readable medium of any one of examples 1 or 2, wherein the instructions cause one of the at least one programmable circuit to validate the first device by causing the first data to be sent to the validated device, the validated device to process the first data to generate the third data, and comparing the third data from the validated device to the first data of the first device.

Example 4 includes the non-transitory computer readable medium of any one of examples 1, 2, or 3, wherein the instructions cause one of the at least one programmable circuit to validate the first device by causing the validated device to move to a location corresponding to a third device, capture fourth data, processes the fourth data to generate the third data, and comparing the third data to the first data.

Example 5 includes the non-transitory computer readable medium of any one of examples 1, 2, 3, or 4, wherein the instructions cause one of the at least one programmable circuit to mitigate the second device when the second data mismatches the third data.

Example 6 includes the non-transitory computer readable medium of any one of examples 1, 2, 3, 4, or 5, wherein the instructions cause one of the at least one programmable circuit to mitigate the second device by adjusting settings of the second device.

Example 7 includes the non-transitory computer readable medium of any one of examples 1, 2, 3, 4, 5, or 6, wherein the instructions cause one of the at least one programmable circuit to mitigate the second device by decreasing a trust score associated with the second device.

Example 8 includes the non-transitory computer readable medium of any one of examples 1, 2, 3, 4, 5, 6, or 7, wherein the instructions cause one of the at least one programmable circuit to mitigate the second device by triggering retraining of a model implemented by the second device.

Example 9 includes the non-transitory computer readable medium of any one of examples 1, 2, 3, 4, 5, 6, 7, or 8, wherein the instructions cause one of the at least one programmable circuit to mitigate the second device by increasing a trust score associated with the first device.

Example 10 includes the non-transitory computer readable medium of any one of examples 1, 2, 3, 4, 5, 6, 7, 8, or 6, wherein the instructions cause one of the at least one programmable circuit to mitigate the second device by deactivating the second device.

Example 11 includes an apparatus comprising interface circuitry to obtain first data from a first device and second data from a second device, computer readable instructions, and programmable circuitry to instantiate validation managing circuitry to, after determining that the first data based on a first sensor corresponding to the first device conflicts with the second data based on a second sensor corresponding to the second device, validate the first device based on third data from a validated device, and mitigation circuitry to mitigate the second device based on the third data.

Example 12 includes the apparatus of example 11, wherein the first data is analysis of fourth data obtained from the first sensor and the third data is analysis of fifth data obtained from the validated device, the validation managing circuitry to validate the first device by determining that the first data from the first device matches the third data from the validated device.

Example 13 includes the apparatus of any one of examples 11 or 12, wherein the validation managing circuitry is to validate the first device by causing the first data to be sent to the validated device, the validated device to process the first data to generate the third data, and comparing the third data from the validated device to the first data of the first device.

Example 14 includes the apparatus of any one of examples 11, 12, or 13, wherein the validation managing circuitry is to validate the first device by causing the validated device to move to a location corresponding to a third device, capture fourth data, processes the fourth data to generate the third data, and comparing the third data to the first data.

Example 15 includes the apparatus of any one of examples 11, 12, 13 or 14, wherein the mitigation circuitry is to mitigate the second device when the second data mismatches the third data.

Example 16 includes the apparatus of any one of examples 11, 12, 13, 14, or 15, wherein the mitigation circuitry is to mitigate the second device by adjusting settings of the second device.

Example 17 includes the apparatus of any one of examples 11, 12, 13, 14, 15 or 16, wherein the mitigation circuitry is to mitigate the second device by decreasing a trust score associated with the second device.

Example 18 includes the apparatus of any one of examples 11, 12, 13, 14, 15, 16, or 17, wherein the programmable circuitry is to cluster the first data and the second data based on a similarity of the first data and the second data.

Example 19 includes a method comprising after determining that a first analysis of first sensor data from a first device conflicts with second analysis of second sensor data from a second device validating, with at least one programmable circuit, the first device based on a third analysis from a validated device, and mitigating, with one or more of the at least one programmable circuit, the second device based on the third analysis.

Example 20 includes the method of example 19, wherein the validating of the first device includes determining that the first analysis from the first device matches the third analysis from the validated device.

Example 21 includes a non-transitory computer readable medium comprising instructions to cause at least one programmable circuit to after determining that first analysis of first sensor data from a first device conflicts with second analysis of second sensor data from a second device validate the first device based on third analysis from a validated device, and at least one of retrain a model implemented by the second device, calibrate a sensor that obtained the second sensor data, or power down the second device based on the second analysis conflicting with the third analysis.

Example 22 includes the non-transitory computer readable medium of example 21, wherein the instructions cause one of the at least one programmable circuit to validate the first device by determining that the first analysis from the first device matches the third analysis from the validated device.

Example 23 includes the non-transitory computer readable medium of any one of examples 21 or 22, wherein the instructions cause one of the at least one programmable circuit to validate the first device by causing the first sensor data to be sent to the validated device, the validated device to process the first sensor data to generate the third analysis, and comparing the third analysis from the validated device to the first analysis of the first device.

From the foregoing, it will be appreciated that example systems, apparatus, articles of manufacture, and methods have been disclosed which facilitate collaborative learning in a multi-sensor environment. Examples disclosed herein cluster analyzed data from a cluster of nodes to identify conflicts in the analysis. Examples disclosed herein determine inaccurate analysis and mitigate the incorrect analysis to increase the accuracy of the system and/or to save resources for less accurate devices. Disclosed systems, apparatus, articles of manufacture, and methods are accordingly directed to one or more improvement(s) in the operation of a machine such as a computer or other electronic and/or mechanical device.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

1. A non-transitory computer readable medium comprising instructions to cause at least one programmable circuit to:
after determining that first data corresponding to a first sensor from a first device conflicts with second data corresponding to a second sensor from a second device:
validate the first device based on third data from a validated device; and
mitigate the second device based on the third data.

2. The non-transitory computer readable medium of claim 1, wherein the first data is analysis of fourth data obtained from the first sensor and the third data is analysis of fifth data obtained from the validated device, the instructions to cause one of the at least one programmable circuit to validate the first device by determining that the first data from the first device matches the third data from the validated device.

3. The non-transitory computer readable medium of claim 1, wherein the instructions cause one of the at least one programmable circuit to validate the first device by:
causing the first data to be sent to the validated device, the validated device to process the first data to generate the third data; and
comparing the third data from the validated device to the first data of the first device.

4. The non-transitory computer readable medium of claim 1, wherein the instructions cause one of the at least one programmable circuit to validate the first device by:
causing the validated device to move to a location corresponding to a third device, capture fourth data, processes the fourth data to generate the third data; and
comparing the third data to the first data.

5. The non-transitory computer readable medium of claim 1, wherein the instructions cause one of the at least one programmable circuit to mitigate the second device when the second data mismatches the third data.

6. The non-transitory computer readable medium of claim 1, wherein the instructions cause one of the at least one programmable circuit to mitigate the second device by adjusting settings of the second device.

7. The non-transitory computer readable medium of claim 1, wherein the instructions cause one of the at least one programmable circuit to mitigate the second device by decreasing a trust score associated with the second device.

8. The non-transitory computer readable medium of claim 1, wherein the instructions cause one of the at least one programmable circuit to mitigate the second device by triggering retraining of a model implemented by the second device.

9. The non-transitory computer readable medium of claim 1, wherein the instructions cause one of the at least one programmable circuit to mitigate the second device by increasing a trust score associated with the first device.

10. The non-transitory computer readable medium of claim 1, wherein the instructions cause one of the at least one programmable circuit to mitigate the second device by deactivating the second device.

11. An apparatus comprising:
interface circuitry to obtain first data from a first device and second data from a second device;
computer readable instructions; and
programmable circuitry to instantiate:
validation managing circuitry to, after determining that the first data based on a first sensor corresponding to the first device conflicts with the second data based on a second sensor corresponding to the second device, validate the first device based on third data from a validated device; and
mitigation circuitry to mitigate the second device based on the third data.

12. The apparatus of claim 11, wherein the first data is analysis of fourth data obtained from the first sensor and the third data is analysis of fifth data obtained from the validated device, the validation managing circuitry to validate the first device by determining that the first data from the first device matches the third data from the validated device.

13. The apparatus of claim 11, wherein the validation managing circuitry is to validate the first device by:
causing the first data to be sent to the validated device, the validated device to process the first data to generate the third data; and
comparing the third data from the validated device to the first data of the first device.

14. The apparatus of claim 11, wherein the validation managing circuitry is to validate the first device by:
causing the validated device to move to a location corresponding to a third device, capture fourth data, processes the fourth data to generate the third data; and
comparing the third data to the first data.

15. The apparatus of claim 11, wherein the mitigation circuitry is to mitigate the second device when the second data mismatches the third data.

16. The apparatus of claim 11, wherein the mitigation circuitry is to mitigate the second device by adjusting settings of the second device.

17. The apparatus of claim 11, wherein the mitigation circuitry is to mitigate the second device by decreasing a trust score associated with the second device.

18. The apparatus of claim 11, wherein the programmable circuitry is to cluster the first data and the second data based on a similarity of the first data and the second data.

19. A method comprising:
after determining that a first analysis of first sensor data from a first device conflicts with second analysis of second sensor data from a second device:
validating, with at least one programmable circuit, the first device based on a third analysis from a validated device; and
mitigating, with one or more of the at least one programmable circuit, the second device based on the third analysis.

20. The method of claim 19, wherein the validating of the first device includes determining that the first analysis from the first device matches the third analysis from the validated device.

21. (canceled)

22. (canceled)

23. (canceled)
